(19) United States
(12) Patent Application Publication
(10) Pub. No.: US 2012/0118587 A1
(43) Pub. Date: May 17, 2012

(54) HORSE HOOF PROTECTIVE DEVICES AND RELATED METHODS

(75) Inventor: Julia Patek, Mora, MN (US)

(73) Assignee: Integrity Horse Products Inc., Mora, MN (US)

(21) Appl. No.: 13/228,611

(22) Filed: Sep. 9, 2011

Related U.S. Application Data
(60) Provisional application No. 61/381,526, filed on Sep. 10, 2010.

(51) Int. Cl. A01L 7/00

(52) U.S. Cl. 168/4

(57) ABSTRACT

The various embodiments disclosed herein relate to horse hoof protective devices, systems, and methods, including, for example, a horse hoof protective device that can be coupled to a horseshoe and is configured to be positioned over a horse's hoof.

### FIELD OF THE INVENTION

The various embodiments disclosed herein relate to horse hoof protective devices, systems, and methods.

### BACKGROUND OF THE INVENTION

Horseshoes have been used to protect horse hooves for hundreds and probably thousands of years. The typical horseshoe is a “nail-on” horseshoe, in which nails are driven into the bottom of the horse's hoof in order to attach the shoe to the hoof.

“Nail-on” horseshoes create various problems, including damage to the horse hoof caused by the nails, inability to change shoes quickly and easily, and recurring costs associated with having “nail-on” horseshoes placed on the horse.

There is a need in the art for improved horse hoof protective devices, systems, and methods.

### BRIEF SUMMARY OF THE INVENTION

One embodiment described herein relates to a horse hoof protective device. The device has a boot, a reinforcement insert positioned within the boot and in contact with the bottom portion, a horseshoe positioned adjacent to the boot and in contact with the bottom portion, and at least one fastener configured to fasten together the boot, the reinforcement insert, and the horseshoe. The boot has a bottom portion defining at least one bottom portion hole and an upper portion coupled to the bottom portion. The upper portion has an upper edge that defines an opening configured to receive a horse hoof. The reinforcement insert defines at least one insert hole. The horseshoe is positioned such that the bottom portion is positioned between the reinforcement insert and the horseshoe, and the horseshoe defines at least one horseshoe hole. The at least one fastener is positioned through the insert hole, the bottom portion hole, and the horseshoe hole.

Another embodiment relates to a horse hoof protective device having a boot, a horseshoe positioned adjacent to the boot and in contact with the bottom portion, at least one fastener positioned through the bottom portion hole and the horseshoe hole, and a securement component coupled to the upper portion. The boot has a bottom portion defining at least one bottom portion hole and an upper portion coupled to the bottom portion. The upper portion has an upper edge that defines an opening configured to receive a horse hoof. The horseshoe defines at least one horseshoe hole. The at least one fastener is configured to fasten together the boot and the horseshoe. The securement component has an attachment component coupled to the upper portion, a rear support component integral with the attachment component, and first and second securement pieces extending from the rear support component. The first and second securement pieces have a fastening component.

A further implementation relates to a horse hoof protective device having a boot, a reinforcement insert, a securement component, and at least one fastener. The boot has a bottom portion that defines at least one bottom portion hole and an upper portion coupled to the bottom portion. The upper portion has an upper edge that defines an opening configured to receive a horse hoof. The reinforcement insert is positioned within the boot and in contact with the bottom portion and defines at least one insert hole. The securement component is coupled to the upper portion. The securement component has an attachment component coupled to the upper portion, a rear support component integral with the attachment component, and first and second securement pieces extending from the rear support component, each of the pieces comprising a fastening component. The at least one fastener is positioned through the insert hole and the bottom portion hole. In addition, the at least one fastener is configured to fasten together the boot and the reinforcement insert and is further configured to be capable of fastening a horseshoe to the boot.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1A is a perspective view of a horse hoof protective device, according to one embodiment.

FIG. 1B is a perspective view of the various components of the horse hoof protective device of FIG. 1A.

FIG. 2A is a perspective view of a securement component coupled to a horse hoof protective device, according to one embodiment.

FIG. 2B is a side view of the securement component of FIG. 2A.

FIG. 2C is a side view of the securement component of FIG. 2A in use.

FIG. 3A is a front view of a securement component coupled to a horse hoof protective device, according to another embodiment.

FIG. 3B is a perspective view of the securement component of FIG. 3A coupled to a horse hoof protective device.

FIG. 3C is a side view of the securement component of FIG. 3A in use.

FIG. 4 is a top view of a tightening component coupled to a horse hoof protective device, according to one embodiment.

FIG. 5 is a top view of two tightening components coupled to a horse hoof protective device, according to another embodiment.

### DETAILED DESCRIPTION

The various embodiments disclosed herein relate to methods and devices for protecting a horse's hoof. Certain embodiments relate to a boot that can be positioned over a horse's hoof and is coupleable to a horseshoe.

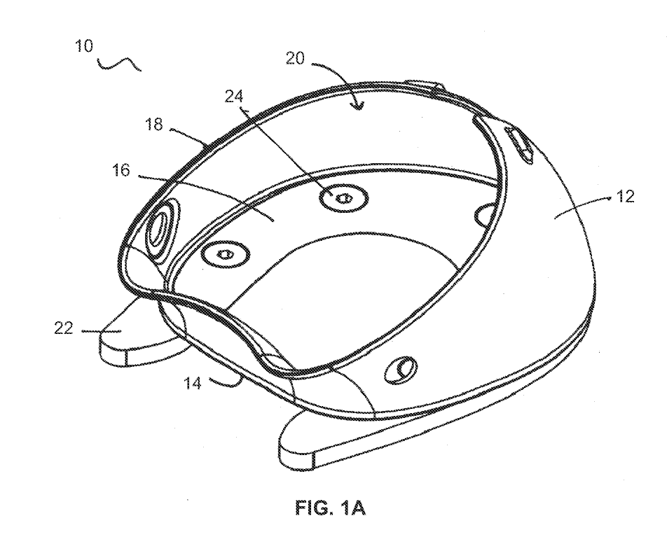

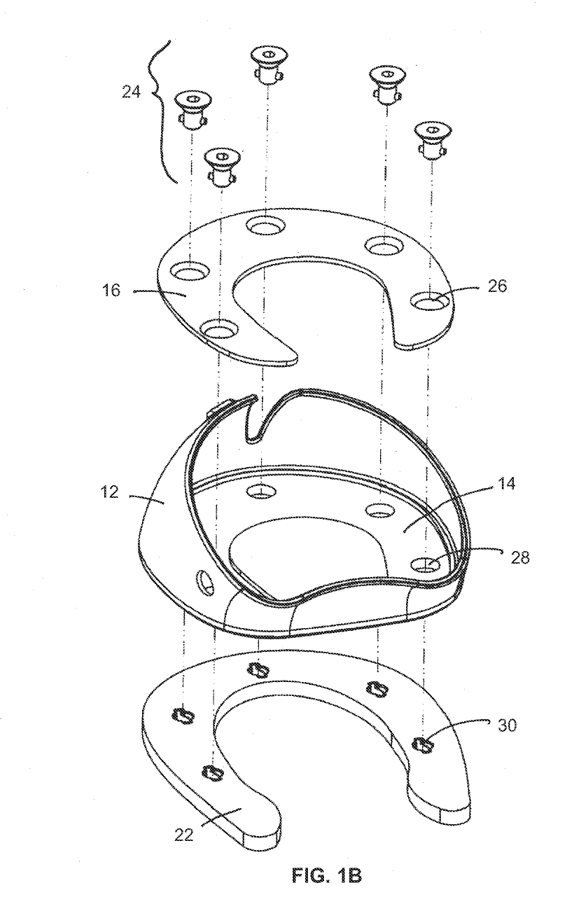

FIGS. 1A and 1B depict a horse boot 10, according to one embodiment. The boot 10 is configured to receive or be positioned over a horse hoof. In this embodiment, the boot 10 has an upper portion 12 and a bottom portion 14, with a reinforcement insert 16 positioned inside the boot 10. The upper portion 12 has a top edge 18 that defines an opening 20 configured to receive the hoof of a horse. In this implementation, as best shown in FIG. 1B, the reinforcement insert 16 is positioned on top of the bottom portion 14. The boot 10 can be coupled to a horseshoe 22.

As best shown in FIG. 1B, in the depicted embodiment, the insert 16, the bottom portion 14 of the boot 10, and the horseshoe 22 are coupled together using fasteners 24. More specifically, the fasteners 24 are positioned through holes 26, 28, 30 defined in each of the insert 16, bottom portion 14, and horseshoe 22, respectively, and thereby fixably attach the three components. According to one embodiment, the bottom portion 14 is positioned between the shoe 22 and the reinforcement insert 16. In an alternative embodiment, the boot 10 has no reinforcement insert and the fasteners 24 are configured to couple the bottom portion 14 to the horseshoe 22.

According to one embodiment, the boot 10 is made of a sturdy rubber or a synthetic rubber copolymer such as Styrene-Butadiene-Rubber (SBR). In a further alternative, the boot 10 is made of any known durable and flexible material, including, for example, abrasion resistant and/or tear resistant materials, that can be used in animal equipment such as, for example, horse equipment.

In accordance with one implementation, the fasteners 24 are pop rivets or screws. Alternatively, the fasteners are any known, commercially available fasteners used on animal equipment and especially horse equipment. In one implementation, there are five fasteners 24 as shown. Alternatively, there are four fasteners 24 and an equivalent four holes 26, 28, 30. In a further alternative, any known number of fasteners 24 can be used with an equivalent known number of holes 26, 28, 30 that could be used with respect to horseshoes and the various embodiments contemplated herein. According to one embodiment, the horseshoe 22 is a commercially-available horseshoe 22 designed for use during sporting or show events. Alternatively, the horseshoe 22 can be any commercially-available horseshoe designed for any purpose.

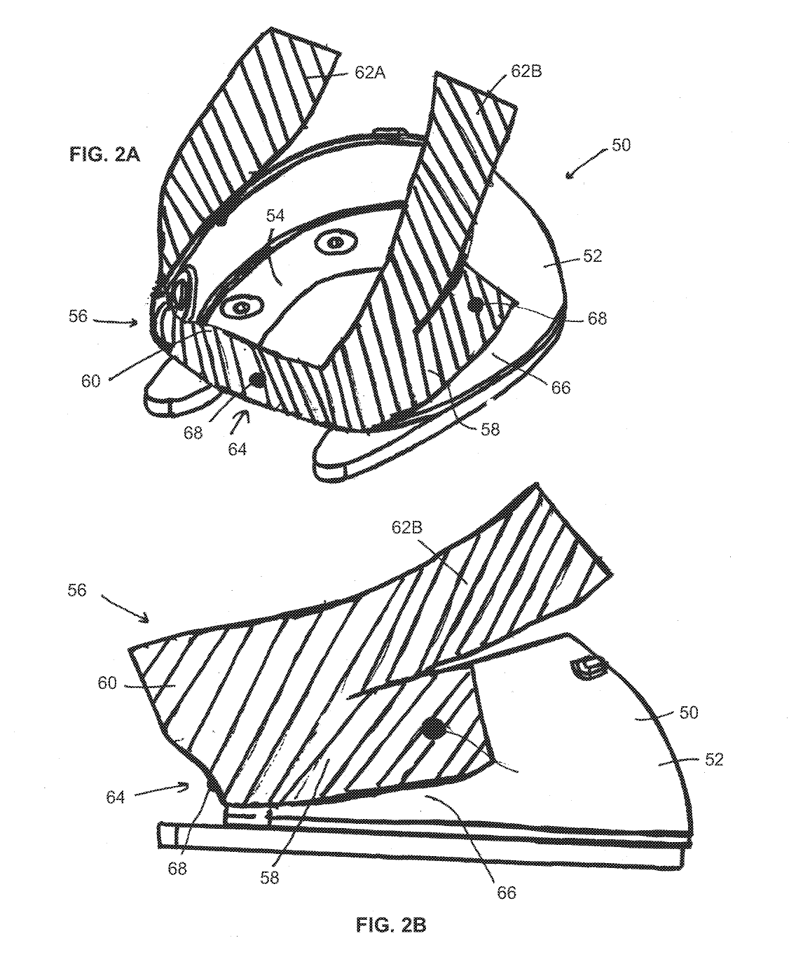

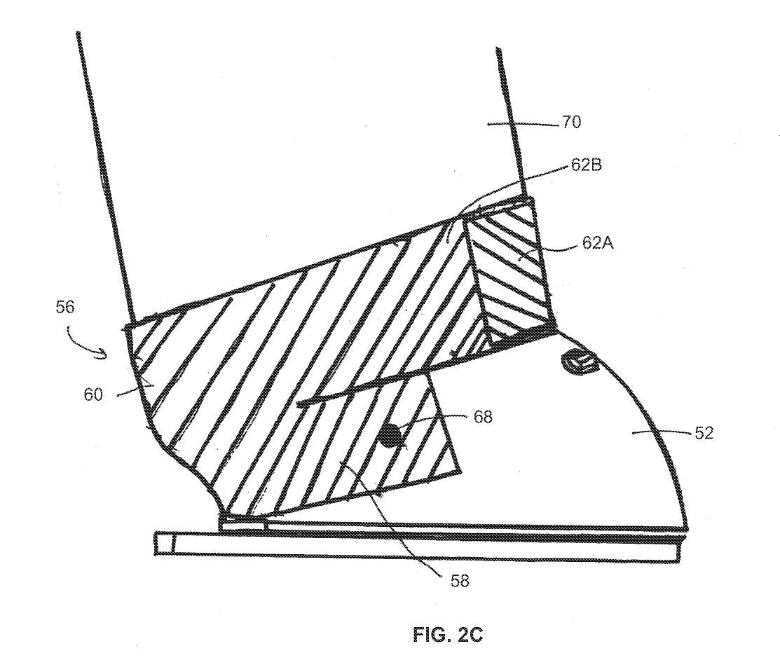

FIGS. 2A, 2B, and 2C depict a further embodiment of a horse boot 50 having a securement component (also referred to herein as a “securement strap”) 56. The boot 50 in this implementation has an upper portion 52, a bottom portion 54, and a securement component 56 that is coupled to the upper portion 52. The securement component 56 has a boot attachment portion 58, a rear support portion 60, and two securement pieces 62A, 62B that are configured to be coupleable to each other. In the embodiment depicted, the attachment portion 58 of the strap 56 is attached along a back portion 64 and along both side portions 66 of the boot 50. In the implementation shown, the attachment portion 58 is attached to the boot 50 via fasteners 68 such as the fasteners 68 depicted in FIGS. 2A and 2B. In another embodiment, the attachment portion 58 is attached to the boot 50 using an adhesive. Alternatively, the attachment portion 58 is attached by any known attachment means or method or combination thereof.

The two securement pieces 62A, 62B both extend from or are coupled to the attachment portion 58 and rear support portion 60 as shown. In use, as best depicted in FIG. 2C, when the boot 50 has been positioned over a horse's hoof, the pieces 62A, 62B are configured to be positionable around a front portion of the leg 70 or hoof of the horse and coupled to each other in a tensioned configuration such that the coupled pieces 62A, 62B are positioned against a front portion of the hoof or leg of the horse, as best shown in FIG. 2C. In accordance with one implementation, a user can pull the pieces 62A, 62B around the front of the horse's leg 70 or hoof and apply force to the pieces 62A, 62B while coupling them together, thereby resulting in the securement strap 56 having a tensioned configuration in which the strap 56 applies pressure upon the horse's leg 70 or hoof. In this tensioned configuration, the securement strap 56 provides support to the horse's hoof and/or leg and further assists with retention or attachment of the boot 50 to the horse's hoof. In one embodiment, each of the securement pieces 62A, 62B has a fastening component (not shown), each of which is configured to fasten to the fastening component on the other piece. In one example, each piece 62A, 62B has a hook-and-loop fastening component configured to be removably attachable to the fastening component on the other piece. Alternatively, the pieces 62A, 62B can have any known fastening components for fastening to each other.

In one embodiment, the securement strap 56 is made of leather. Alternatively, the securement pieces 62A, 62B are made of an elastic material that allows the user to stretch the pieces 62A, 62B while attachment them to each other. In a further alternative, the strap 56 and securement pieces 62A, 62B can be made of any known flexible, durable material that can be positioned around and attached to a horse boot and can further be wrapped around and provide support to a horse hoof or leg.

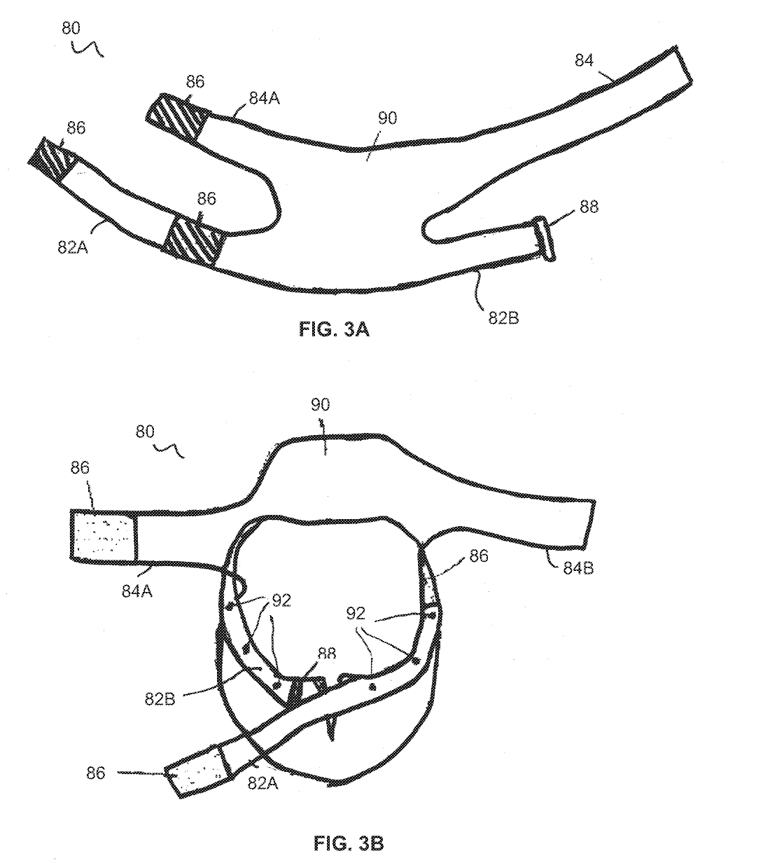

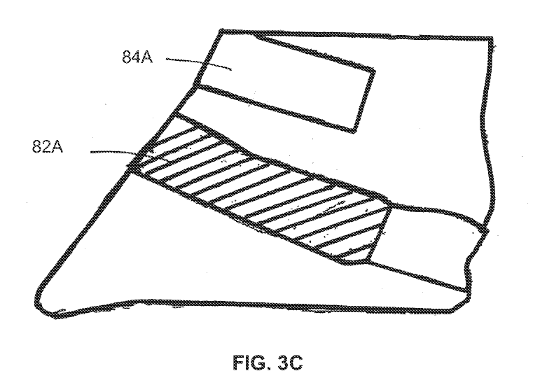

FIGS. 3A, 3B, and 3C depict a further embodiment of a securement component 80 that can be coupled to the horse boot 50 of FIGS. 2A-2C. In contrast to the securement strap 56 described above, which has only two securement pieces 62A, 62B that can be coupled to each other, the securement component 80 has four securement pieces, including the lower securement pieces 82A, 82B and the upper securement pieces 84A, 84B. In one embodiment, the various securement pieces 82A, 82B, 84A, 84B can have attachment components 86 that can be used to couple those pieces to the corresponding pieces or some portion of the boot 50. In one embodiment, the attachment components 86 are sections of Velcro™ 86. Alternatively, the attachment components 86 can be any known devices or components for attaching the securement pieces to each other or the boot 50.

In one implementation, at least one of the securement pieces can have a buckle. For example, in the implementation as best shown in FIGS. 3A and 3B, the securement piece 82B has a buckle 88 through which securement piece 82A can be threaded to secure the pieces 82A, 82B to the boot 50. Alternatively, one or more of the other securement pieces can have a buckle.

According to one embodiment, the securement component 80 can also have an elastic portion 90. In the embodiment shown in FIGS. 3A and 3B, the elastic portion is integral with a middle portion of the securement component 80. Alternatively, each of the securement pieces 82A, 82B, 84A, 84C can have an elastic portion.

As best shown in FIG. 3B, the securement pieces 82A, 82B are coupled to the upper portion 52 of the boot 50. In the embodiment depicted, the securement pieces 82A, 82B are coupled to the upper portion with rivets 92. Alternatively, the securement pieces 82A, 82B are coupled with any known attachment devices or components, such as, for example, screws 92. In use, as best depicted in FIG. 3C, when the boot 50 has been positioned over a horse's hoof, the pieces 82A, 82B are coupled to each other in a tensioned configuration such that the coupled pieces 82A, 82B are positioned against a front portion of the hoof or leg of the horse. In accordance with one implementation, a user can apply force to the pieces 82A, 82B while coupling them together, thereby resulting in the securement strap 80 having a tensioned configuration in which the strap 80 applies pressure upon the boot 50. For example, in one embodiment, the securement piece 82A can be threaded through the buckle 88 and tensioned and then folded back and the attachment component 86 can be attached to a portion of the securement piece 82A itself that is proximal to the distal end of the piece 82A. Alternatively, the securement piece 82A can be threaded through the buckle 88 and tensioned and the attachment component 86 can be attached to a portion of the securement piece 82B.

Similarly, the securement pieces 84A, 84B are configured to be coupled to each other around a portion of the horse's hoof or leg as best shown in FIG. 3C. In use, when the boot 50 has been positioned over a horse's hoof (and before or after the securement pieces 82A, 82B have been coupled together), the securement pieces 84A, 84B are coupled to each other in a tensioned configuration such that the coupled pieces 84A, 84B are positioned against a front portion of the hoof or leg of the horse. In accordance with one implementation, a user can apply force to the pieces 84A, 84B while coupling them together, thereby resulting in the securement strap 80 having a tensioned configuration in which the strap 80 helps to secure the boot 50 to the horse's hoof.

In this tensioned configuration, the securement strap 80 provides support to the horse's hoof and/or leg and further assists with retention or attachment of the boot 50 to the horse's hoof.

In one embodiment, the securement strap 80 is made of leather. Alternatively, the securement pieces 82A, 82B, 84A, 84B are made of an elastic material that allows the user to stretch the pieces 82A, 82B, 84A, 84B while attachment them to each other. In a further alternative, the strap 80 and securement pieces 82A, 82B, 84A, 84B can be made of any known flexible, durable material that can be positioned around and attached to a horse boot and can further be wrapped around and provide support to a horse hoof or leg.

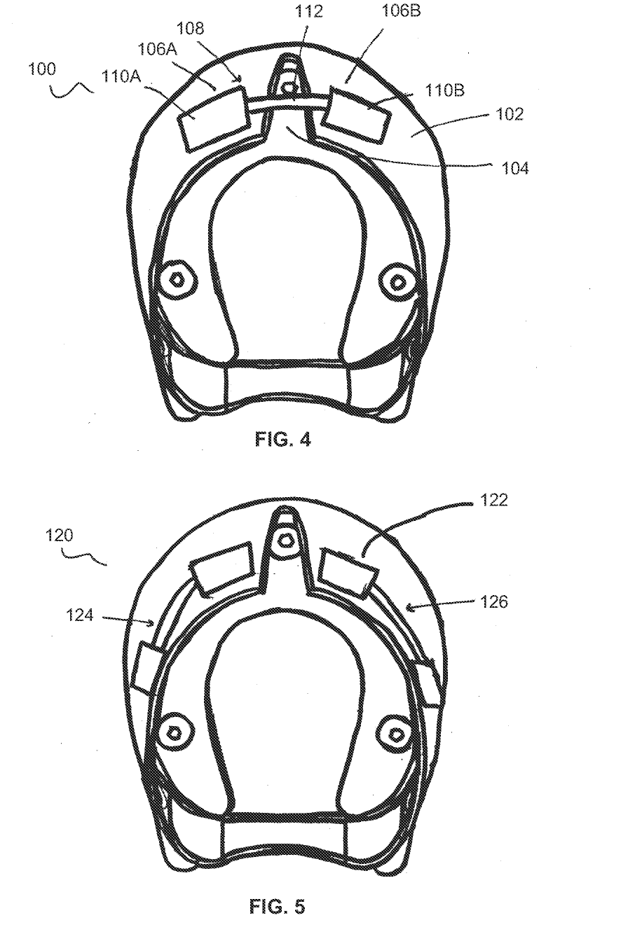

FIG. 4 depicts a further embodiment of a horse boot 100 having an upper portion 102 that has a gap 104 defined between two front portions 106A, 106B of the upper portion 102. According to one implementation, the gap 104 is intended to provide some variability as to the size of hoof over which the boot 100 can be positioned. That is, the gap 104 can expand to allow a larger hoof to be positioned in the boot 104 than would be able to fit without the gap 104. In addition, the gap 104, in combination with a tightening component 108, can be used to fit the boot 100 to a smaller hoof. As shown, the tightening component 108 has first and second attachment components 110A, 110B that are configured to attach the tightening component 108 to the two front portions 106A, 106B, respectively, of the boot 100. In this embodiment, the two attachment components 110A, 110B are coupled to each other with a tensionable connector 108 that can be tightened or shortened to urge the two attachment components 110A, 110B toward each other and thereby urge the two front portions 106A, 106B toward each other. In one embodiment, the tightening component 102 is a latch 102 similar to a latch on a ski boot. Alternatively, the tightening component 102 can be any component for urging the two front portions 106A, 106B toward each other and thereby configure the boot 100 to fit on a hoof that is smaller than if there were no tightening component 108.

In a further embodiment as shown in FIG. 5, a horse boot 120 is provided that has two tightening components 124, 126 that are positioned on opposite sides of the upper portion 122 of the boot 120. In this embodiment, one or both of the tightening components 124, 126 can be tightened to reduce the size of the opening that receives a horse hoof, thereby allowing the boot 120 to fit securely over smaller hoofs.

In another implementation, a boot can have both a securement strap and one or more tightening components as contemplated herein.

Although the present invention has been described with reference to preferred embodiments, persons skilled in the art will recognize that changes may be made in form and detail without departing from the spirit and scope of the invention.

What is claimed is:

1. A horse hoof protective device, comprising
(a) a boot comprising:
a bottom portion, the bottom portion defining at least one bottom portion hole;
(ii) an upper portion coupled to the bottom portion, the upper portion having an upper edge, wherein the upper edge defines an opening configured to receive a horse hoof;
(b) a reinforcement insert positioned within the boot and in contact with the bottom portion, the reinforcement insert defining at least one insert hole;
(c) a horseshoe positioned adjacent to the boot and in contact with the bottom portion such that the bottom portion is positioned between the reinforcement insert and the horseshoe, the horseshoe defining at least one horseshoe hole; and
(d) at least one fastener configured to fasten together the boot, the reinforcement insert and the horseshoe, wherein the at least one fastener is positioned through the insert hole, the bottom portion hole, and the horseshoe hole.

2. The device of claim 1, further comprising a securement strap coupled to the upper portion of the boot, the securement strap comprising first and second securement pieces configured to be positionable around a front portion of a horse leg and further configured to be coupleable to each other.

3. The device of claim 2, wherein each of the first and second securement pieces comprise a fastening component.

4. The device of claim 1, further comprising a tightening component coupled to the upper portion of the boot.

5. The device of claim 1, further comprising a gap defined in a front portion of the upper portion.

6. The device of claim 5, further comprising a tightening component coupled to the upper portion of the boot, wherein the tightening component comprises a first attachment component positioned on one side of the gap and a second attachment component positioned on an opposing side of the gap.

7. A horse hoof protective device, comprising
(a) a boot comprising:
a bottom portion, the bottom portion defining at least one bottom portion hole;
(ii) an upper portion coupled to the bottom portion, the upper portion having an upper edge, wherein the upper edge defines an opening configured to receive a horse hoof;
(b) a horseshoe positioned adjacent to the boot and in contact with the bottom portion, the horseshoe defining at least one horseshoe hole;
(c) at least one fastener configured to fasten together the boot and the horseshoe, wherein the at least one fastener is positioned through the bottom portion hole and the horseshoe hole; and
(d) a securement component coupled to the upper portion, the securement component comprising:
an attachment component coupled to the upper portion;
(ii) a rear support component integral with the attachment component; and
(iii) first and second securement pieces extending from the rear support component, each of the first and second securement pieces comprising a fastening component.

8. The device of claim 7, wherein the first and second securement pieces comprise an elastic material.

9. The device of claim 7, wherein the first and second securement pieces are configured to be positioned around a leg of a horse, wherein the first securement piece fastening component is configured to couple to the second securement piece fastening component.

10. The device of claim 7, further comprising a reinforcement insert positioned within the boot and in contact with the bottom portion such that the bottom portion is positioned between the reinforcement insert and the horseshoe, the reinforcement insert defining at least one insert hole, wherein the at least one fastener is further configured to fasten together the reinforcement insert, the boot, and the horseshoe, wherein the at least one fastener is positioned through the insert hole, the bottom portion hole, and the horseshoe hole.

11. The device of claim 7, further comprising a tightening component coupled to the upper portion of the boot.

12. The device of claim 11, wherein the tightening component comprises
(a) a first attachment component coupled to the upper portion;
(b) a second attachment component coupled to the upper portion; and
(c) a connector coupling the first and second attachment components.

13. The device of claim 11, wherein the tightening component is a latch component.

14. The device of claim 7, wherein the boot further comprises a gap defined in a front portion of the upper portion.

15. The device of claim 14, further comprising a tightening component coupled to the upper portion, wherein the tightening component is positioned across the gap.

16. The device of claim 14, further comprising a first tightening component coupled to the upper portion on a first side of the gap and a second tightening component coupled to the upper portion on a second side of the gap.

17. A horse hoof protective device, comprising
(a) a boot comprising:
a bottom portion, the bottom portion defining at least one bottom portion hole;
(ii) an upper portion coupled to the bottom portion, the upper portion having an upper edge, wherein the upper edge defines an opening configured to receive a horse hoof;
(b) a reinforcement insert positioned within the boot and in contact with the bottom portion, the reinforcement insert defining at least one insert hole;
(c) a securement component coupled to the upper portion, the securement component comprising:
an attachment component coupled to the upper portion;
(ii) a rear support component integral with the attachment component; and
(iii) first and second securement pieces extending from the rear support component, each of the first and second securement pieces comprising a fastening component; and
(d) at least one fastener configured to fasten together the boot and the reinforcement insert, wherein the at least one fastener is positioned through the insert hole and the bottom portion hole, wherein the at least one fastener is further configured to be capable of fastening a horseshoe to the boot.

18. The device of claim 17, further comprising the horseshoe fastened to the bottom portion of the boot, the horseshoe comprising at least one horseshoe hole, wherein the at least one fastener is positioned through the a horseshoe hole.

19. The device of claim 17, further comprising a tightening component coupled to the upper portion, wherein the tightening component is configured to be moveable between a non-tight configuration and a tight configuration.

20. The device of claim 19, wherein the tightening component is positioned across a gap defined in the upper portion.
